(19) United States
(12) Patent Application Publication
(10) Pub. No.: US 2026/0212546 A1
(43) Pub. Date: Jul. 23, 2026

(54) MODIFYING VECTOR ART VIA LIVE COLOR REDUCTION USING COLOR CLUSTERING AND PATH DOMINANCE

(71) Applicant: Adobe Inc., San Jose, CA (US)

(72) Inventors: Shivali Gakhar, Noida (IN); Radhika Jhawar, Noida (IN)

(21) Appl. No.: 19/035,524

(22) Filed: Jan. 23, 2025

(51) Int. Cl. G06T 11/00; G06F 3/04845; G06T 7/90; G06T 11/60; G06V 10/74; G06V 10/762

(52) U.S. Cl. CPC G06T 11/10; G06F 3/04845; G06T 7/90; G06T 11/60; G06V 10/761; G06V 10/762

(57) ABSTRACT

The present disclosure relates to systems, methods, and non-transitory computer-readable media that reduce the color palette of a vector artwork while retaining one or more color values of the original palette. For example, in some embodiments, the disclosed systems extract, from a vector artwork displayed within a graphical user interface of a client device, a color palette that includes a set of color values. Additionally, the disclosed systems receive, via the client device, user input for reducing the color palette of the vector artwork. In response to the user input, the disclosed systems determine a subset of color values that includes one or more color values from the set of color values. The disclosed systems further modify the vector artwork within the graphical user interface of the client device by reducing the set of color values within the vector artwork to the subset of color values.

### BACKGROUND

Recent years have seen significant advancement in hardware and software platforms for editing vector art. Indeed, as the use of vector art has become increasingly ubiquitous, systems have developed to facilitate the manipulation of the content within such vector art. To illustrate, many systems offer various tools that enable various changes to the color palette of vector art.

### SUMMARY

One or more embodiments described herein provide benefits and/or solve one or more problems in the art with systems, methods, and non-transitory computer-readable media that implement an accurate and efficient approach for reducing the color palette of a vector artwork while maintaining one or more of the color values originally portrayed therein. For instance, in some embodiments, a system implements a vector-based framework for color management that uses color clustering and vector path dominance to identify and prioritize significant colors within the color palette of vector artwork. Thus, upon modifying a vector artwork to reduce its color palette, the system maintains the dominant color values, using those colors to replace less significant ones. Further, in some cases, the system provides an interface-based slider that enables a user to fine-tune the color palette of displayed vector artwork in real time. In this manner, the system provides an approach for accurate vector-based color reduction with real-time feedback to user input.

Additional features and advantages of one or more embodiments of the present disclosure are outlined in the description which follows, and in part will be obvious from the description, or are learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a color reduction system operates in accordance with one or more embodiments;

FIG. 2 illustrates the color reduction system reducing the color palette of a vector artwork while maintaining one or more of its original color values in accordance with one or more embodiments;

FIG. 3 illustrates the color reduction system extracting and analyzing the vector paths of a vector artwork in accordance with one or more embodiments;

FIG. 4 illustrates the color reduction system clustering one or more color values of a vector artwork in accordance with one or more embodiments;

FIG. 5 illustrates the color reduction system determining a reduced color palette in accordance with one or more embodiments;

FIG. 6 illustrates the color reduction system modifying a vector artwork using a reduced color palette in accordance with one or more embodiments;

FIG. 7 illustrates the color reduction system replacing a color value that is part of a gradient fill in accordance with one or more embodiments;

FIG. 8 illustrates the color reduction system increasing the number of color values for a vector artwork based on additional user input in accordance with one or more embodiments;

FIG. 9 illustrates an example schematic diagram of a color reduction system in accordance with one or more embodiments;

FIG. 10 illustrates a flowchart of a series of acts for reducing the color palette of a vector artwork while maintaining one or more original color values in accordance with one or more embodiments; and

FIG. 11 illustrates a block diagram of an exemplary computing device in accordance with one or more embodiments.

### DETAILED DESCRIPTION

One or more embodiments described herein include a color reduction system that accurately and efficiently modifies vector art to portray reduced color palettes that include original color values via vector-based color snapping. For instance, in some cases, the color reduction system extracts the color palette from a vector artwork and clusters the color values included therein to reduce the number of colors in the artwork while preserving the most significant ones. In some embodiments, the color reduction system further determines a reduced color palette for the vector artwork in response to user input by selecting the most dominant colors. In some instances, the color reduction system receives the user input through a slider element provided within the graphical user interface displaying the vector artwork. The color reduction system snaps the colors of the vector artwork to the reduced palette to provide an editing result. In some instances, the color reduction system performs the vector-based color snapping for vector art portraying gradient colors and/or implements stroke management.

To illustrate, in one or more embodiments, the color reduction system extracts, from a vector artwork displayed within a graphical user interface of a client device, a color palette that includes a set of color values. The color reduction system further receives, via the client device, user input for reducing the color palette of the vector artwork. In response to the user input, the color reduction system determines a subset of color values that includes one or more color values from the set of color values. The color reduction system modifies the vector artwork within the graphical user interface of the client device by reducing the set of color values within the vector artwork to the subset of color values.

As just indicated, in one or more embodiments, the color reduction system reduces the color palette of a vector artwork while maintaining one or more of the original color values. In particular, in some embodiments, the color reduction system determines a reduced color palette that includes a subset of the color values from the original color palette. Thus, the color reduction system modifies a vector artwork by reducing the number of colors portrayed therein while maintaining the original values of those colors that remain.

As further mentioned, in certain embodiments, the color reduction system implements a vector-based approach to color reduction. In particular, in some embodiments, the color reduction system processes a vector artwork directly to reduce its color palette.

To illustrate, in one or more embodiments, the color reduction system determines the color palette of a vector artwork using vector path extraction and color value identification. In some cases, the color reduction system clusters color values from the color palette based on a measure of similarity between color value pairs, selecting a representative color value for each cluster. The color reduction system sorts the remaining color values, including the representative color values, based on dominance. In some implementations, the color reduction system determines the dominance of a color value based on the total area of the vector artwork occupied by the color value (including the area of any other color value clustered with that color value).

Further, in some embodiments, the color reduction system determines a reduced color palette for the vector artwork using the sorted color values. For example, in some cases, the color reduction system receives user input indicating that n color values are to be included in the reduced color palette. Thus, the color reduction system selects the top n color values (e.g., the n most dominant color values). The color reduction system snaps the color values of the vector artwork to the reduced color palette. For instance, in some cases, the color reduction system replaces a first color value with a second color values from the reduced color palette based on a similarity between those color values (e.g., based on the first color value being more similar to the second color value than any of the other color values from the reduced color palette). Thus, the color reduction system provides an editing result by modifying the vector to portray the reduced color palette.

Additionally, as mentioned, in some implementations, the color reduction system receives the user input indicating the number of color values for the reduced color palette via a slider element presented within a graphical user interface of a client device. In particular, in some cases, the color reduction system provides the slider element for display within the graphical user interface displaying the vector artwork. Thus, in some instances, the color reduction system enhances the editing process through a live editing environment through which a user interacts with the color reduction dynamically and immediate feedback is provided.

The color reduction system provides advantages over conventional systems. Indeed, conventional color reduction systems suffer from several technological shortcomings that result in inaccurate, inefficient, and inflexible operation. To illustrate, many conventional systems are inaccurate in that they fail to accurately reduce the color palette of a vector artwork while maintaining any original color values. Rather, these systems often recolor the vector artwork with a new set color values. For instance, upon detecting user input for reducing a vector artwork's color palette, many conventional systems take various averages of the original color values and apply these averages to recolor the artwork. Other systems that attempt to adhere more closely to the original color palette still tend to provide results that suffer from excessive color variance, a change in the tone of those colors that are maintained, and/or the loss of crucial visual detail.

Additionally, many conventional color reduction systems fail to operate efficiently. For example, some conventional systems perform color reduction via raster-based snapping. In particular, these systems typically convert vector artwork to a raster copy to extract its color palette. As such, these systems extract color information from pixel data for further processing (e.g., via k-means clustering), causing the color extraction to be time consuming and computationally demanding as upwards of millions of pixels must be analyzed to obtain the desired information. As a result, there is often a significant time delay between receiving user input for reducing the color palette and providing the editing results.

Further, conventional color reduction systems often fail to operate flexibly. For example, conventional systems often fail to accommodate certain image features—such as strokes —of a vector artwork. For instance, many systems modify the stroke colors along with the fill colors of a vector artwork, often leading to the loss of the stroke details. Indeed, in many instances, these systems provide editing results in which the stroke color blends in with the fill color such that the stroke is no longer distinctly visible.

One or more embodiments of the color reduction system operate with improved accuracy when compared to conventional systems. For instance, embodiments of the color reduction system more accurately reduces the color palette of a vector artwork while maintaining the original values of those colors that remain. In other words, the color reduction system more accurately preserves the original color values while reducing the color palette. Thus, the color reduction system provides editing results that are more representative of the original artwork.

Additionally, one or more embodiments of the color reduction system operate with improved efficiency when compared to conventional systems. Indeed, by processing a vector artwork directly to reduce its color palette, the color reduction system reduces the demands on time and computational resources of conventional systems. For instance, by extracting and analyzing the vector paths of a vector artwork rather than the pixels of a corresponding raster copy, the color reduction system processes tens or hundreds of vector paths rather than millions of pixels. Thus, the color reduction system simplifies the color reduction process, significantly reducing the time between receiving user input and providing editing results—often providing the editing result in real time (e.g., nearly instantaneously).

Further, one or more embodiments of the color reduction system operate with improved flexibility. In particular, embodiments of the color reduction system more flexibly accommodate various image features of a vector artwork—such as strokes depicted therein—that are not taken into account under conventional systems. Indeed, embodiments of the color reduction system manage the strokes of a vector artwork separately, allowing the strokes to maintain their visual distinctiveness in the editing result.

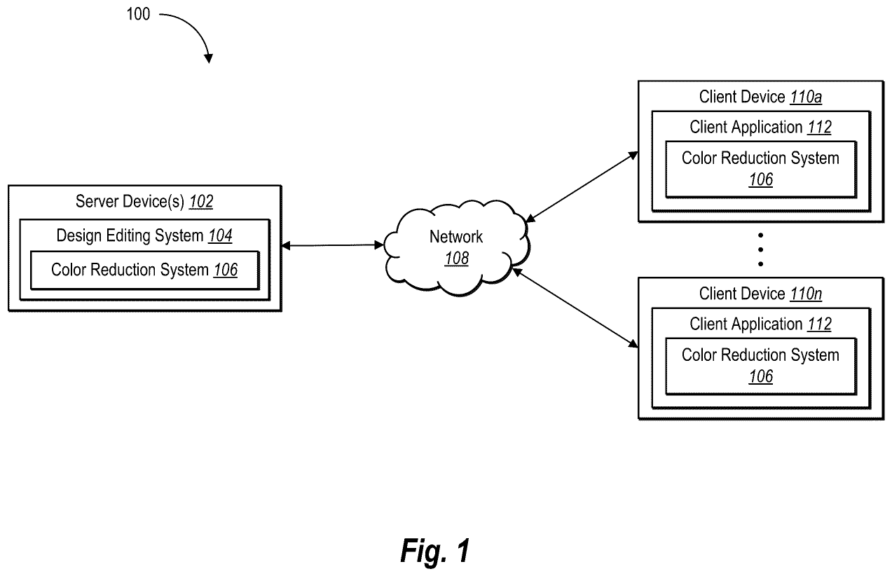

Additional detail regarding the color reduction system will now be provided with reference to the figures. For example, FIG. 1 illustrates a schematic diagram of an exemplary system 100 in which a color reduction system 106 operates. As illustrated in FIG. 1, the system 100 includes a server device(s) 102, a network 108, and client devices 110a-110n.

Although the system 100 of FIG. 1 is depicted as having a particular number of components, the system 100 is capable of having any number of additional or alternative components (e.g., any number of server devices, client devices, or other components in communication with the color reduction system 106 via the network 108). Similarly, although FIG. 1 illustrates a particular arrangement of the server device(s) 102, the network 108, and the client devices 110a-110n, various additional arrangements are possible.

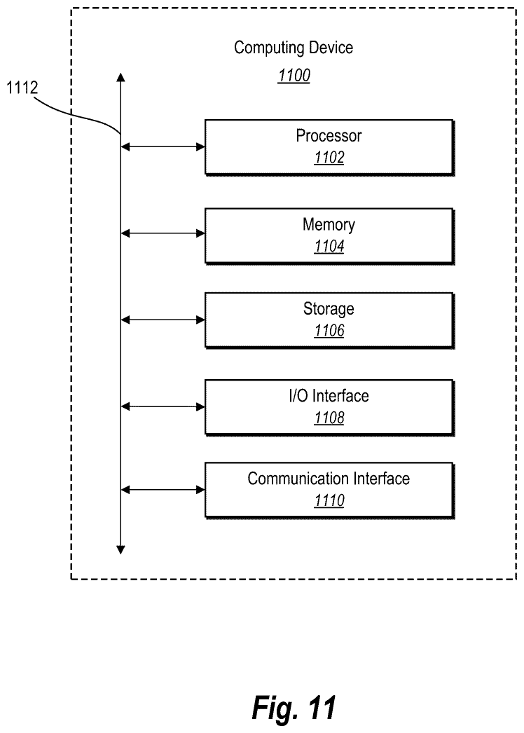

The server device(s) 102, the network 108, and the client devices 110a-110n are communicatively coupled with each other either directly or indirectly (e.g., through the network 108 discussed in greater detail below in relation to FIG. 11). Moreover, the server device(s) 102 and the client devices 110a-110n include one or more of a variety of computing devices (including one or more computing devices as discussed in greater detail with relation to FIG. 11).

As mentioned above, the system 100 includes the server device(s) 102. In one or more embodiments, the server device(s) 102 generates, stores, receives, and/or transmits data, including vector art and modified vector art having reduced color palettes. In one or more embodiments, the server device(s) 102 comprises a data server device. In some implementations, the server device(s) 102 comprises a communication server device or a web-hosting server device.

In one or more embodiments, the design editing system 104 provides functionality by which a client device (e.g., a user of one of the client devices 110a-110n) generates, edits, manages, and/or stores vector art. For example, in some instances, a client device sends a vector artwork to the design editing system 104 hosted on the server device(s) 102 via the network 108. The design editing system 104 then provides many options that the client device may use to edit the vector artwork, store the vector artwork, and subsequently search for, access, and view the vector artwork. For instance, in some cases, the design editing system 104 provides one or more options that the client device may use to reduce the color palette of a vector artwork while maintaining one or more of its original color values.

In one or more embodiments, the client devices 110a-110n include computing devices that are capable of accessing, modifying, and/or storing vector art, including modified vector art having reduced color palettes. For example, in some embodiments, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that are capable of accessing, modifying, and/or storing vector art, including modified vector art having reduced color palettes. For example, in some embodiments, the client application 112 includes a software application installed on the client devices 110a-110n. Additionally, or alternatively, the client application 112 includes a web browser or other application that accesses a software application hosted on the server device(s) 102 (and supported by the design editing system 104).

To provide an example implementation, in some embodiments, the color reduction system 106 on the server device(s) 102 supports the color reduction system 106 on the client device 110n. For instance, in some cases, the color reduction system 106 on the server device(s) 102 determines a reduced color palette for a vector artwork. The color reduction system 106 then, via the server device(s) 102 communicates the reduced color palette to the client device 110n. The color reduction system 106 on the client device 110n responds to user input by modifying the vector artwork using the reduced color palette.

In alternative implementations, the color reduction system 106 includes a web hosting application that allows the client device 110n to interact with content and services hosted on the server device(s) 102. To illustrate, in one or more implementations, the client device 110n accesses a software application supported by the server device(s) 102. The client device 110n provides input to the server device(s) 102, such as a vector artwork to be modified and a number of color values to use in the modification. In response, the color reduction system 106 on the server device(s) 102 modifies the vector artwork by reducing its color palette to the indicated number of color values. The server device(s) 102 then provides the modified vector artwork to the client device 110n for display.

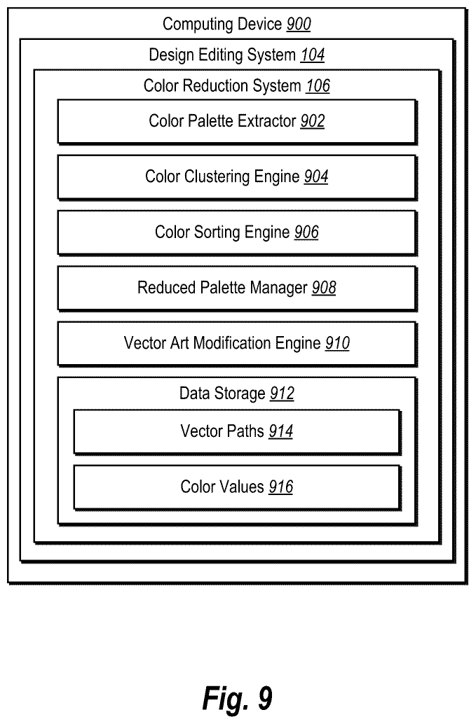

Indeed, the color reduction system 106 is able to be implemented in whole, or in part, by the individual elements of the system 100. Indeed, although FIG. 1 illustrates the color reduction system 106 being implemented with regard to the server device(s) 102, different components of the color reduction system 106 are able to be implemented by a variety of devices within the system 100. For example, in some cases, one or more (or all) components of the color reduction system 106 are implemented by a different computing device (e.g., one of the client devices 110a-110n) or a separate server device from the server device(s) 102 hosting the design editing system 104. Indeed, as shown in FIG. 1, the client devices 110a-110n include the color reduction system 106. Example components of the color reduction system 106 will be described below with regard to FIG. 9.

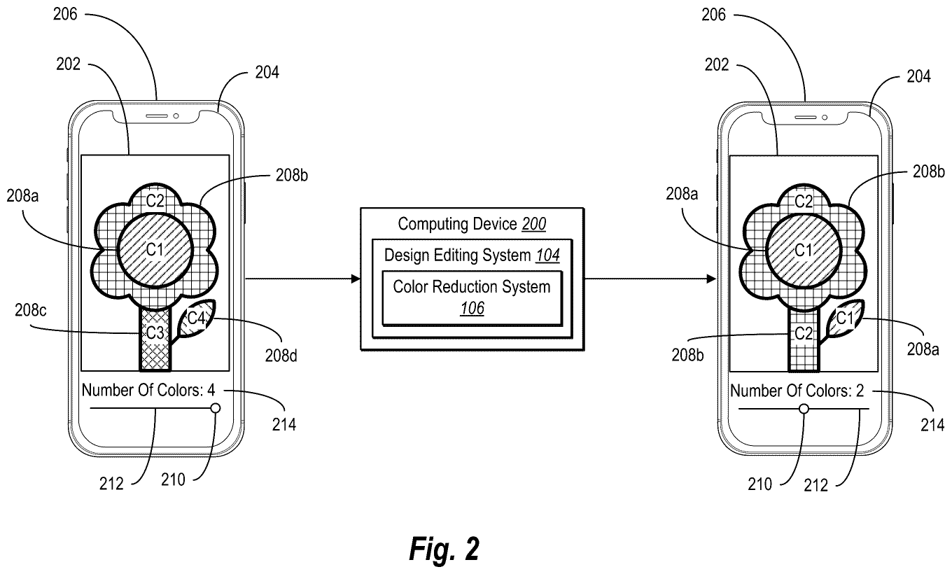

As mentioned, in one or more embodiments, the color reduction system 106 modifies a vector artwork by reducing its color palette. Further, the color reduction system 106 maintains one or more of the original color values within the reduced color palette. FIG. 2 illustrates the color reduction system 106 reducing the color palette of a vector artwork while maintaining one or more of its original color values in accordance with one or more embodiments.

In one or more embodiments, a color value includes a numerical representation of a color. In particular, in some embodiments, a color value includes a numerical representation that enables a corresponding color to be displayed by a graphical system, such as within a vector artwork. Indeed, in some cases, a color value includes a set of numerical values that specify the intensity or proportion of color components that make up the corresponding color. In certain instances, a color value includes a fill color, a color stop of a gradient fill, or a stroke color.

In one or more embodiments, a color value is associated with a color format. In other words, in some cases, the color value is formatted in accordance with a color format, or the numerical values of a color value provide information in accordance with the color format. For instance, in some embodiments, a color value is associated with a red, blue, green (RGB) color format. Thus, in certain cases, a color value includes a set of three numerical values that specify the intensity or proportion of, respectively, red, blue, and green that make up the corresponding color. As another example, in some implementations, a color value is associated with a cyan, magenta, yellow, and key (CMYK) color format. As such, in some embodiments, a color value includes a set of four numerical values that specify the intensity or proportion of, respectively, cyan, magenta, yellow, and key (e.g., black) that make up the corresponding color.

Additionally, in one or more embodiments, a color palette includes a set of color values (e.g., a set of colors represented by the set of color values). Thus, in some embodiments, a color palette of a vector artwork includes a set of color values of the vector artwork. In particular, in some cases, a color palette of a vector artwork includes a set of one or more color values depicted within the vector artwork such that each color value from the color palette (e.g., the color represented by each color value) occupies one or more portions of the vector artwork.

In one or more embodiments, an original color palette more particularly includes the color palette originally depicted by a vector artwork. In particular, in some embodiments, an original color palette includes the set of color values originally depicted within a vector artwork (e.g., the set of colors represented by those color values). Indeed, in some cases, an original color palette includes the set of color values depicted within a vector artwork in its initial (e.g., unmodified) state. For instance, in some instances, an original color palette includes the set of color values originally depicted within a vector artwork before the vector artwork is modified via a color reduction process.

In some embodiments, a reduced color palette includes a color palette having a subset of color values from the set of color values of another color palette. In particular, in some embodiments, a reduced color palette includes a color palette that is derived from another color palette and includes a subset of the color values of the other color palette. Indeed, in some cases, a reduced color palette includes a modified color palette, where the color palette was modified to include at least one less color value. To illustrate, in some cases, a reduced color palette includes a color palette that is derived from the original color palette of a vector artwork and includes a subset of the color values of the original color palette such that the reduced color palette includes at least one fewer color value than the original color palette. In one or more embodiments, each color value included in a reduced color palette is also included in the set of color values from which the reduced color palette was derived. For instance, in certain implementations, each color value included in a reduced color palette determined for a vector artwork is a color value from the original color palette of the vector artwork.

Indeed, as shown in FIG. 2, the color reduction system 106 (operating on the computing device 200) provides a vector artwork 202 for display within a graphical user interface 204 of a client device 206. As shown, the vector artwork 202 includes a color palette having a set of color values 208a-208d. In other words, the vector artwork 202 depicts the color values 208a-208d from the color palette (e.g., depicts the colors represented by the color values 208a-208d). Indeed, each color value from the set of color values 208a-208d occupies one or more portions of the vector artwork 202. In some cases, the set of color values 208a-208d represents the original color palette of the vector artwork 202.

Additionally, as shown in FIG. 2, the color reduction system 106 provides a slider element 210 within the graphical user interface 204. In one or more embodiments, a slider element includes an interactive graphical user interface element that is moveable across one or more lines. In particular, in some embodiments, a slider element includes a graphical user interface element that moves across one or more horizontal lines, vertical lines, and/or diagonal lines in response to one or more user interactions. Indeed, as shown in FIG. 2, the color reduction system 106 provides the slider element 210 for display in association with a horizontal line 212, indicating that the slider element 210 is moveable across the horizontal line 212.

In one or more embodiments, the color reduction system 106 uses the slider element 210 to determine a user selection (or a default selection) of the number of color values to be depicted within the vector artwork 202. In particular, in some embodiments, the color reduction system 106 determines the user selection (or the default selection) based on a position of the slider element 210 along the horizontal line 212. For instance, in some cases, the color reduction system 106 determines that a position of the slider element 210 at a rightmost position of the horizontal line 212 (as illustrated in FIG. 2) corresponds to a user selection of the original color palette of the vector artwork 202 (e.g., the full set of color values from the original color palette) and determines that positions to the left of the rightmost position correspond to a user selection of a reduced color palette (e.g., a lesser number of color values). It should be understood, however, that the color reduction system 106 uses various configurations in various implementations. For instance, in some cases, the color reduction system 106 determines that the leftmost position of the horizontal line 212 corresponds to a user selection of the original color palette and that positions to the right of the leftmost position correspond to a user selection of a reduced color palette.

As shown in FIG. 2, the color reduction system 106 also provides an indicator 214 within the graphical user interface 204 to indicate the number of color values represented within the vector artwork 202. Thus, in some cases, the color reduction system 106 modifies the indicator 214 as the number of color values within the vector artwork 202 changes. For instance, in some cases, the color reduction system 106 modifies the indicator 214 in accordance with the number of color values selected via one or more user interactions with the slider element 210 (e.g., in accordance with modifications to the vector artwork 202 performed in response to the one or more user interactions).

As shown in FIG. 2, the color reduction system 106 modifies the vector artwork 202. In particular, the color reduction system 106 receives user input and modifies the vector artwork 202 in response. Indeed, as illustrated, the color reduction system 106 receives one or more user interactions that move the slider element 210 to the left along the horizontal line 212. Thus, the color reduction system 106 determines to modify the vector artwork 202 by modifying the color palette depicted by the vector artwork 202. In particular, the color reduction system 106 determines to reduce the color palette of the vector artwork 202 in accordance with the user input.

Indeed, as illustrated in FIG. 2, the color reduction system 106 determines that the position of the slider element 210—after being repositioned via the one or more user interactions —indicates that only two color values are to be represented within the vector artwork 202. Thus, the color reduction system 106 determines to reduce the color palette of the vector artwork 202 to two color values. Thus, the color reduction system 106 determines a reduced color palette for the vector artwork 202 that includes a subset of the color values from the original color palette of the vector artwork 202. Determining a reduced color palette for a vector artwork will be discussed in more detail with respect to the following figures.

As shown, the color reduction system 106 modifies the vector artwork 202 using the reduced color palette. In particular, the color reduction system 106 modifies the vector artwork 202 to portray the reduced color palette in accordance with the user input received via the slider element 210. Indeed, as shown in FIG. 2, the color reduction system 106 modifies the vector artwork 202 by replacing the third color value 208c with the second color value 208b and by replacing the fourth color value 208d with the first color value 208a. Thus, in response to the user input, the color reduction system 106 determines a reduced color palette that includes the first color value 208a and the second color value 208b but omits the third color value 208c and the fourth color value 208d. As further shown, the color reduction system 106 updates the indicator 214 in accordance with the change to the vector artwork 202 using the reduced color palette.

While FIG. 2 illustrates the color reduction system 106 reducing the color palette of the vector artwork 202 based on user interactions with the slider element 210, the color reduction system 106 uses other interactive elements in other embodiments. For instance, in some cases, the color reduction system 106 provides a drop-down menu that provides selectable options for numbers of color values or provides buttons for incrementally increasing or decreasing the number of color values represented in the vector artwork.

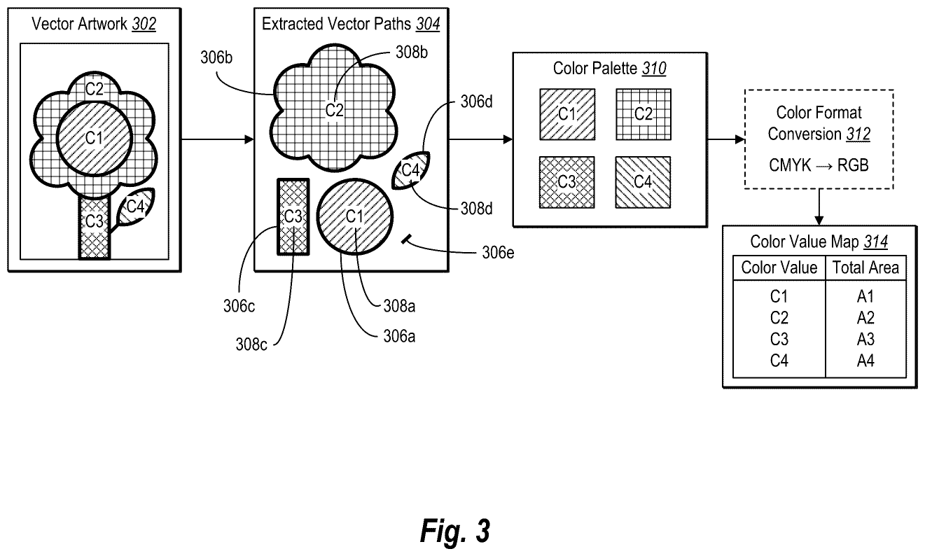

As mentioned, in one or more embodiments, the color reduction system 106 determines a reduced color palette for a vector artwork by analyzing the vector artwork directly. For instance, in some embodiments, the color reduction system 106 extracts and analyzes the vector paths of a vector artwork. FIG. 3 illustrates the color reduction system 106 extracting and analyzing the vector paths of a vector artwork in accordance with one or more embodiments.

In one or more embodiments, a vector path includes a line or outline within a vector artwork. In particular, in some embodiments, a vector path includes a line or outline created by connecting a series of points. For instance, in some cases, a vector path includes an outline of an object portrayed in a vector artwork. In some instances, a vector path includes a mathematical construct in which the points to be connected are defined by coordinates and the line our outline connecting the points are mathematically connected, enabling the resulting vector path to be scaled up or down without losing quality.

As shown in FIG. 3, the color reduction system 106 extracts a color palette 310 from a vector artwork 302. In particular, as illustrated, the color reduction system 106 extracts a set of vector paths 304 from the vector artwork 302 and determines the color palette 310 by determining the color values associated with each vector path. For instance, FIG. 3 illustrates the set of vector paths 304 including a first vector path 306a, a second vector path 306b, a third vector path 306c, a fourth vector path 306d, and a fifth vector path 306e. Further, FIG. 3 illustrates that the first vector path 306a is associated with a first color value 308a, the second vector path 306b is associated with a second color value 308b, the third vector path 306c is associated with a third color value 308c, the fourth vector path 306d is associated with a fourth color value 308d, and the fifth vector path 306e is associated with no color value. Thus, the color reduction system 106 determines that the color palette 310 of the vector artwork 302 includes the first color value 308a, the second color value 308b, the third color value 308c, and the fourth color value 308d (e.g., the color palette 310 includes the colors represented by these color values).

It should be noted that the color values 308a-308d in this case include color values for fill colors. Thus, the fifth vector path 306e is not associated with a color value for a fill color (e.g., the fifth vector path 306e does not outline a space occupied by a fill color). In some instances, however, the color reduction system 106 determines that the fifth vector path 306e is associated with a color value for a stroke (i.e., a stroke color) and managing stroke colors will be discussed in more detail below.

Additionally, as illustrated in FIG. 3, in some implementations, the color reduction system 106 performs a color format conversion 312. In particular, the color reduction system 106 converts the color values of the color palette 310 from a first color format to a second color format. For instance, as illustrated, the color reduction system 106 converts the color values of the color palette 310 from a CMYK color format to an RGB color format.

Indeed, as discussed previously, color values are associated with various color formats in various implementations. Thus, in some cases, the color reduction system 106 performs color reduction for vector art that adheres to these various formats. In some implementations, to facilitate a consistent color space for subsequent processing, the color reduction system 106 implements a standard color format and converts color values associated with other color formats to the standard color format. FIG. 3 illustrates an embodiment in which the color reduction system 106 uses the RGB color format as the standard color format, but the color reduction system 106 uses various color formats as the standard color format in various implementations. Further, FIG. 3 illustrates the color reduction system 106 performing the color format conversion 312 based on the color values of the color palette 310 being associated with a color format other than the standard color format. In certain cases, however, where the color values of the color palette 310 are already associated with the standard color format (e.g., the RGB color format), the color reduction system 106 does not perform the color format conversion 312.

As further shown in FIG. 3, the color reduction system 106 generates a color value map 314 from the color palette 310 (e.g., in the standard color format). In one or more embodiments, a color value map includes a mapping of color values to the areas of a vector artwork occupied by those color values. In particular, in some embodiments, a color value map maps a color value to the total area of a vector artwork occupied by that color value. For example, in some instances, a color value map includes a map having color values as keys and the total areas occupied by the color values as values of those keys.

To illustrate, as the color palette 310 includes the first color value 308a, the second color value 308b, the third color value 308c, and the fourth color value 308d, the color reduction system 106 generates the color value map 314 to map these color values to their total occupied areas within the vector artwork 302. As FIG. 3 illustrates each color value associated with a single vector path within the vector artwork 302, the color reduction system 106 determines that the total area of each color value includes the area associated with the corresponding vector path (e.g., the area outlined by the vector path). In some cases, however, the color reduction system 106 determines that a color value is associated with multiple vector paths within a vector artwork. In such cases, the color reduction system 106 determines that the total area for that color value is equal to the combined areas associated with those vector paths. For instance, in certain cases where a color value is associated with two vector paths, the color reduction system 106 determines a first area associated with the first vector path, determines a second area associated with the second vector path, and determines that the total area for the color value includes the sum of the first and second areas.

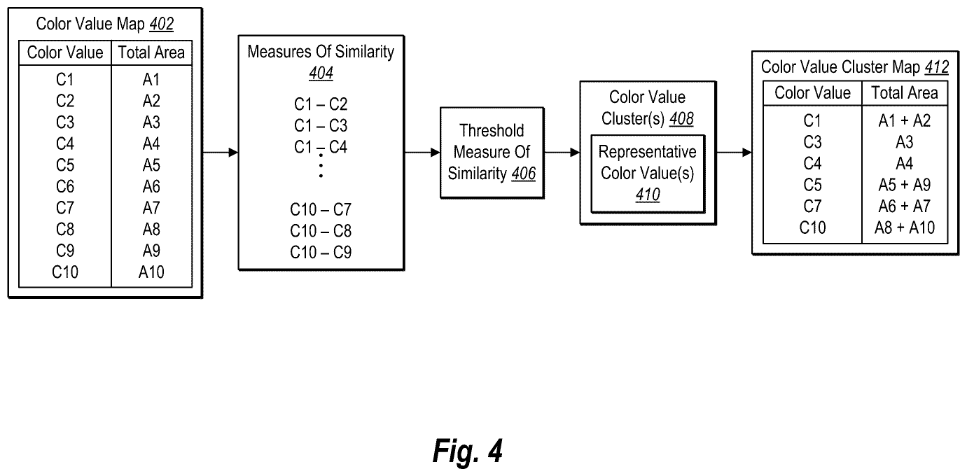

As previously mentioned, in some embodiments, the color reduction system 106 clusters one or more color values of a color palette extracted from a vector artwork. FIG. 4 illustrates the color reduction system 106 clustering one or more color values of a vector artwork in accordance with one or more embodiments.

As shown in FIG. 4, the color reduction system 106 generates a color value map 402 that maps a set of color values extracted from a vector artwork to the total areas of the vector artwork occupied by those color values. For instance, in some cases, the color reduction system 106 generates the color value map 402 as described above with reference to FIG. 3. It should be noted, however, that the color value map 402 is different from the color value map 314 discussed with reference to FIG. 3. In particular, the color value map 402 includes additional color values and their corresponding total areas—a total of ten each—to better illustrate the color clustering performed by the color reduction system 106.

As further shown in FIG. 4, the color reduction system 106 further determines measures of similarity 404 between color values represented in the color value map 402. In one or more embodiments, a measure of similarity includes an indication of the similarity between color values. In particular, in some embodiments, a measure of similarity includes a metric that indicates the similarity between a pair of color values. For instance, in some cases, a measure of similarity provides a numerical value that indicates the similarity between two color values. Indeed, as indicated in FIG. 4, the color reduction system 106 determines the measures of similarity 404 for pairs of color values represented in the color value map 402. In particular, the color reduction system 106 determines a measure of similarity for each pair of color values.

In one or more embodiments, the color reduction system 106 determines a measure of similarity for a pair of color values by determining the Euclidean distance between the color values. In particular, the color reduction system 106 determines the Euclidean distance within a color space. For example, where the color values are in an RGB format, the color reduction system 106 determines the distance between the color values within an RGB space. To illustrate, in some cases, the color reduction system 106 uses the RGB values of each color value as coordinates of the color value within a three-dimensional space and determines the distance between the color values (e.g., the straight-line distance) based on their respective coordinates.

Additionally, as shown in FIG. 4, the color reduction system 106 compares the measures of similarity 404 to a threshold measure of similarity 406. In one or more embodiments, a threshold measure of similarity includes a threshold similarity value for clustering color values. In particular, in some embodiments, a threshold measure of similarity includes a value used by the color reduction system 106 to determine whether two color values are similar enough to cluster. In some instances, the threshold measure of similarity 406 is configurable. For instance, in certain implementations, the color reduction system 106 modifies the threshold measure of similarity 406 based on user input.

Indeed, in one or more embodiments, the color reduction system 106 determines one or more color value clusters 408 based on comparing the measures of similarity 404 to the threshold measure of similarity 406. In one or more embodiments, a color value cluster includes a group of two or more color values. In particular, in some embodiments, a color value cluster includes a group of at least two color values having a measure of similarity that satisfies a threshold measure of similarity. For instance, in some cases, a color value cluster includes a group of at least two color values that have been determined to be close enough within a color space—in view of a threshold measure of similarity—to be managed together for further processing. In some cases, a color value cluster includes two or more color values having a similar appearance (e.g., different shades of the same hue); in some instances, however, a color value cluster includes color values that differ in appearance based on having a large enough threshold measure of similarity.

As indicated in FIG. 4, the one or more color value clusters 408 includes one or more representative color values 410. In particular, each color value cluster includes a representative color value. In one or more embodiments, a representative color value includes a color value selected to represent a color value cluster. In particular, in some cases, a representative color value includes a color value that is included in a color value cluster and selected to represent the color value cluster. For instance, in some cases, a representative color value includes a single color value from a color value cluster that is selected to be the color value representing the color value cluster.

Indeed, in one or more embodiments, upon determining to cluster two or more color values, the color reduction system 106 selects one of the color values to be a representative color value for that color value cluster. In other words, the color reduction system 106 selects a color value to be the single color value representing the whole cluster. In one or more embodiments, the color reduction system 106 selects, as the representative color value, the color value from the color value cluster that occupies the most total area within the vector artwork. In other words, in some cases, the color reduction system 106 selects the most dominant color value from the cluster to be the representative color value for the cluster.

As shown in FIG. 4, the color reduction system 106 generates a color value cluster map 412 based on determining the one or more color value clusters 408. In one or more embodiments, the color reduction system 106 generates the color value cluster map 412 by modifying the color value map 402 based on determining the one or more color value clusters 408..

In one or more embodiments, a color value cluster map includes a mapping of individual color values to the areas of a vector artwork occupied by those color values and/or a mapping of color value clusters to the areas of a vector artwork occupied by those color value clusters. In particular, in some embodiments, a color value cluster map maps a color value or color value cluster to the total area of a vector artwork occupied by that color value or color value cluster, respectively. For example, in some instances, a color value cluster map includes a map having color values and/or color value clusters as keys and the total areas occupied by the color values and/or color value clusters as values of those keys.

Indeed, as shown in FIG. 4, the color value cluster map 412 maps individual color values (e.g., C3 and C4) to the total area of the vector artwork occupied by each of those color values (e.g., A3 and A4, respectively). Further, the color value cluster map 412 maps color value clusters to the total area occupied by each of those color value clusters. In particular, the color value cluster map 412 maps the representative color values (e.g., C1, C5, C7, and C10) of the color value clusters to the total area occupied by each of those color value clusters (e.g., A1+A2, A5+A9, A6+A7, and A8+A10, respectively). In one or more embodiments, the color reduction system 106 determines the total area of a vector artwork occupied by a color value cluster by determining the sum of the total areas of the color values in the color value cluster.

To illustrate, as indicated by FIG. 4, the color reduction system 106 determines to cluster the color values C1 and C2. Further, the color reduction system 106 selects C1 as the representative color value for the color value cluster. For instance, in some cases, the color reduction system 106 selects C1 as the representative color value based on determining that the total area of the vector artwork occupied by C1 is larger than the total area occupied by C2. Based on selecting C1 as the representative color value, the color reduction system 106 generates the color value cluster map 412 to list C1 for the color value cluster (rather than listing C2). Further, the color reduction system 106 generates the color value cluster map 412 to list—as the total area occupied by the color value cluster of C1 and C2—the sum of the total areas of the individual color values (i.e., A1+A2).

Thus, in one or more embodiments, the color reduction system 106 generates the color value cluster map 412 to better identify unique colors within a vector artwork. In one or more embodiments, the color reduction system 106 limits the number of color values included within a color value cluster to a predetermined number. For instance, in some embodiments, the color reduction system 106 only clusters pairs of color values. To illustrate, upon determining that the measures of similarity between a first color value and two other color values satisfies the threshold measure of similarity, the color reduction system 106 clusters the first color value with the other color value that is closest in the color space. In some implementations, however, the color reduction system 106 clusters a color value with every other color value having a measure of similarity with the color value that satisfies the threshold measure of similarity.

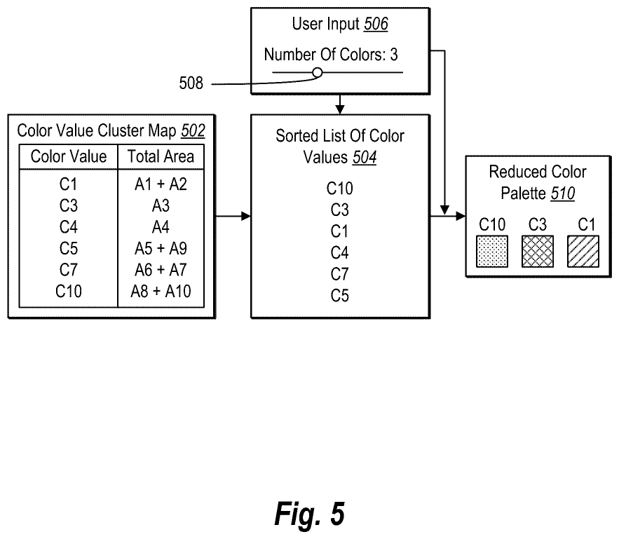

As previously mentioned, in one or more embodiments, the color reduction system 106 determines a reduced color palette for a vector artwork by determining a subset of color values for the vector artwork. In particular, the color reduction system 106 determines a subset of color values from the set of color values of the color palette extracted from the vector artwork (e.g., the original color palette). In some cases, the color reduction system 106 uses a color value map or color value cluster map in determining the subset of color values of the reduced color palette. FIG. 5 illustrates the color reduction system 106 determining a reduced color palette in accordance with one or more embodiments.

As shown in FIG. 5, the color reduction system 106 generates a sorted list of color values 504 from a color value cluster map 502 (e.g., a color value cluster map generated as discussed above with reference to FIG. 4). In one or more embodiments, the color reduction system 106 generates the sorted list of color values 504 by sorting the color values from the color value cluster map 502 (the individual color values and/or the representative color values selected for determined color value clusters) based on their dominance within the corresponding vector artwork. For instance, in some cases, the color reduction system 106 sorts the color values based on the total area of the vector artwork occupied by each color value (the total area associated with the color value within the color value cluster map 502, which includes the total area associated with a color value cluster for representative color values). Thus, the color reduction system 106 generates the sorted list of color values 504 to list the color values from the color value cluster map 502 in descending order or ascending order based on dominance (e.g., total area).

As further shown in FIG. 5, the color reduction system 106 receives user input 506. In particular, FIG. 5 illustrates the color reduction system 106 receiving the user input 506 by receiving one or more user interactions with a slider element 508 displayed within a graphical user interface of a client device, such as the client device displaying the corresponding vector artwork. The color reduction system 106 determines that the user input 506 indicates that the color palette of the vector artwork is to be reduced. Further, the color reduction system 106 determines a number of color values to be included in the reduced color palette based on the user input 506. For instance, FIG. 5 illustrates the user input 506 indicating that the reduced color palette is to include three color values—a reduction from the ten color values included in the original color palette.

As further shown in FIG. 5, the color reduction system 106 uses the sorted list of color values 504 and the user input 506 to determine a reduced color palette 510 for the vector artwork. For instance, the color reduction system 106 identifies the number of color values selected via the user input 508—in this case, three color values. The color reduction system 106 further determines, from the sorted list of color values 504, a top number of color values that is equal to the number of color values selected via the user interaction—in this case, the top three color values. The color reduction system 106 includes those color values within the reduced color palette 510 and omits other color values from the reduced color palette 510.

Thus, as the sorted list of color values 504 organizes the included color values based on their dominance (e.g., total areas) within the corresponding vector artwork, the color reduction system 106 determines the reduced color palette 510 to include those color values that are most dominant based on the user input 506. Indeed, the color reduction system 106 determines, for the reduced color palette 510, a subset of color values from the set of color values of the original color palette. The subset of color values that is selected include those n color values (and/or color value clusters) that occupy the most area within the vector artwork, where the value of n is determined via the user input 506.

In one or more embodiments, the color reduction system 106 does not cluster any color values from the color palette of a vector artwork; thus, the color reduction system 106 does not generate a color value cluster map. For instance, in some implementations, the color reduction system 106 determines that no pairs of color values from the color palette satisfy a threshold measure of similarity. Thus, the color reduction system 106 maintains each color value individually. In some cases, where color values are not clustered, the color reduction system 106 generates the sorted list of color values directly from the color value map generated from the vector artwork. In particular, the color reduction system 106 sorts the color values from the color value map based on the dominance of each color value. In other words, the color reduction system 106 sorts the color values based on the total area occupied by that particular color value within the vector artwork.

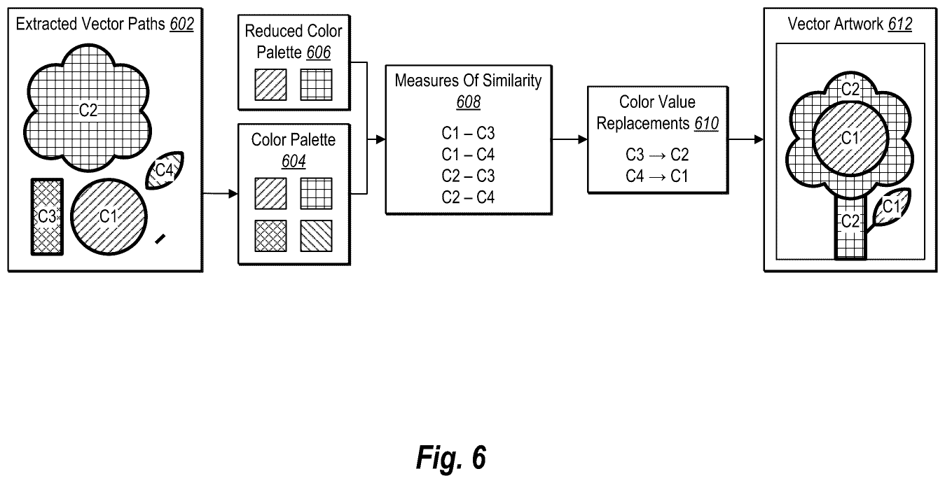

As mentioned above, in one or more embodiments, the color reduction system 106 modifies a vector artwork using a reduced color palette determined in response to user input selecting a number of color values to include in the reduced color palette. In particular, in some embodiments, the color reduction system 106 modifies the vector artwork by replacing the current color palette of the vector artwork (e.g., the original color palette) with the reduced color palette. FIG. 6 illustrates the color reduction system 106 modifying a vector artwork using a reduced color palette in accordance with one or more embodiments.

As shown in FIG. 6, the color reduction system 106 uses a reduced color palette 606 to replace a color palette 604 (e.g., an original color palette) determined using a set of vector paths 602 extracted from a vector artwork. In one or more embodiments, the set of vector paths 602 correspond to the set of vector paths 304 discussed above with reference to FIG. 3. Indeed, FIG. 6 uses the vector artwork having a smaller color palette than that shown in FIGS. 4-5 to better illustrate the replacement of a color palette with a reduced color palette.

Additionally, as shown in. FIG. 6, the color reduction system 106 determines measures of similarity 608 using the color palette 604 and the reduced color palette 606. In particular, the color reduction system 106 determines measures of similarity between those color values included in the reduced color palette 606 and those color values included in the color palette 604 but excluded from the reduced color palette 606. To illustrate, FIG. 6 shows that the color palette 604 includes four color values—C1, C2, C3, and C4. Additionally, the reduced color palette 606 includes C1 and C2 but excludes C3 and C4. For instance, in some cases, upon determining that received user input indicates that the reduced color palette 606 is to include two color values, the color reduction system 106 determines that C1 and C2 are the most dominant color values (e.g., color values occupying the largest total areas within the vector artwork). Thus, upon determining the measures of similarity 608, the color reduction system 106 determines a first measure of similarity between C1 and C3, a second measure of similarity between C1 and C4, a third measure of similarity between C2 and C3, and a fourth measure of similarity between C2 and C4.

As described above, in some cases, the color reduction system 106 determines a measure of similarity between a pair of color values by determining a distance between the color values within a color space. For instance, where the color values include RGB values, the color reduction system 106 determines the position of each color value within the color space based on its RGB value and determines the distance the position of each color value.

As illustrated in FIG. 6, based on the measures of similarity 608 the color reduction system 106 determines color value replacements 610. For instance, FIG. 6 shows that the color reduction system 106 determines to replace C3 with C2 and replace C4 with C1 within the vector artwork. In one or more embodiments, the color reduction system 106 determines to replace C3 with C2 based on the measure of similarity between C3 and C2 indicating a higher level of similarity than the measure of similarity between C3 and C1. In other words, the color reduction system 106 determines that C2 is more similar to C3 than is C1. Similarly, in one or more embodiments, the color reduction system 106 determines to replace C4 with C1 based on the measure of similarity between C4 and C1 indicating a higher level of similarity than the measure of similarity between C4 and C2. In other words, the color reduction system 106 determines that C1 is more similar to C4 than C2 is. In one or more embodiments, the color reduction system 106 determines that a first measure of similarity indicates a higher level of similarity than a second measure of similarity by determining that the first level of similarity indicates a smaller distance between its corresponding color values in a color space than the second measure of similarity. Thus, in one or more embodiments, the color reduction system 106 determines to replace C3 with C2 based on determining that C2 is closer than C1 to C3 within the color space. Similarly, the color reduction system 106 determines to replace C4 with C1 based on determining that C1 is closer than C2 to C4 in the color space.

As further shown in FIG. 6, the color reduction system 106 modifies the vector artwork 612 using the color value replacements 610. In other words, the color reduction system 106 replaces those color values omitted from the reduced color palette 606 with those color values that have been included.

In some implementations, the color reduction system 106 more thoroughly iterates over each vector path of the vector artwork in determining how to apply the reduced color palette 606. To illustrate, in some cases, the color reduction system 106 determines the color value associated with a given vector path and determines measures of similarity between that color value and each color value from the reduced color palette 606. In some cases, the color reduction system 106 determines that the color value of the vector path is an exact math with a color value from the reduced color palette 606. In other words, the color reduction system 106 determines that the color value of the vector path is included in the reduced color palette 606. For example, in some cases, the color reduction system 106 determines that the measure of similarity between the color value of the vector path and the color value from the reduced color palette 606 indicates they are the same color (e.g., the distance between the color values within the color space is zero). Thus, the color reduction system 106 determines to maintain the color value for the vector path (e.g., the color reduction system 106 does not replace the color value within the vector artwork). In certain cases, however, the color reduction system 106 determines that the color value of the vector path is not included in the reduced color palette 606. Thus, the color reduction system 106 uses the measures of similarity to determine the color value from the reduced color palette 606 that is most similar to the color value of the vector path. The color reduction system 106 replaces the color value of the vector path with this color value from the reduced color palette 606.

Thus, in one or more embodiments, the color reduction system 106 modifies a vector artwork in response to user input by reducing the color palette of the vector artwork to a number of color values indicated by the user input.

As indicated in FIG. 6, the color reduction system 106 maintains the stroke colors of the strokes when reducing the color palette of the vector artwork 612. In particular, the color reduction system 106 maintains the color values of the strokes within a vector artwork. In one or more embodiments, a stroke includes an outline or border of a shape, line, or path within a vector artwork. Thus, in some embodiments, a stroke color includes a color value associated with a stroke.

Indeed, in one or more embodiments, the color reduction system 106 manages the strokes of a vector artwork separately from the vector paths. In particular, the color reduction system 106 manages the stroke colors of a vector artwork separately from its fill colors. In other words, in certain embodiments, the color reduction system 106 does not include the stroke colors in the color value map generated from the vector paths extracted from a vector artwork (nor in the subsequent color value cluster map and sorted list of color values). For instance, in some cases, the color reduction system 106 does not includes the stroke colors with the fill color values to avoid blending the strokes with the fill colors when applying the reduced color palette. Indeed, in managing the stroke colors with the fill color values, the color reduction system 106 would risk losing the visual distinction of the strokes within the vector artwork.

Thus, in some embodiments, the color reduction system 106 does not apply color reduction to the strokes of a vector artwork to maintain their visual distinctiveness. In some implementations, however, the color reduction system 106 does apply color reduction to the strokes of a vector artwork but manages the stroke colors separately from the fill colors. To illustrate, in one or more embodiments, the color reduction system 106 generates a color value map for the fill colors of a vector artwork and generates a separate color value map for the stroke colors. The color reduction system 106 further generates separate color value cluster maps and sorted lists from each color value map. Thus, the color reduction system 106 maintains separation between the color values of the stroke colors and fill colors when performing the color reduction. In one or more embodiments, the color reduction system 106 provides at least two interactive elements (e.g., slider elements) to facilitate separate user input for stroke colors and fill colors.

By performing the color reduction as described above, the color reduction system 106 operates with improved accuracy when compared to conventional systems. In particular, the color reduction system 106 produces a color-reduction result that more closely adheres to the original color scheme. Indeed, where many conventional systems change the color scheme—such as by changing the tone of the colors or by averaging the color values—the color reduction system 106 maintains color values that were originally present in the vector artwork.

Additionally, by determining a reduced color palette for a vector artwork based on an analysis of its vector paths, the color reduction system 106 operates more efficiently when compared to conventional systems. In particular, the color reduction system 106 operates on the vector artwork directly—rather than generating and analyzing a raster copy, as is done in many conventional systems—simplifying the color reduction process. Indeed, by analyzing vector paths rather than pixels, the color reduction system 106 significantly reduces the amount of components that need to be analyzed, thereby reducing the computational resources required to perform the color reduction. In many instances, the color reduction system 106 provides instantaneous feedback in response to receiving user input.

Further, by separately managing stroke colors within a vector artwork, the color reduction system 106 operates with improved flexibility when compared to conventional systems. Indeed, while many conventional systems manage stroke colors and fill colors together—which risks losing their visual distinction in the editing result—the color reduction system 106 manages these color values separate to maintain that visual distinction. Thus, the color reduction system 106 more flexibly adheres to the original visual characteristics of vector artwork throughout the color reduction process.

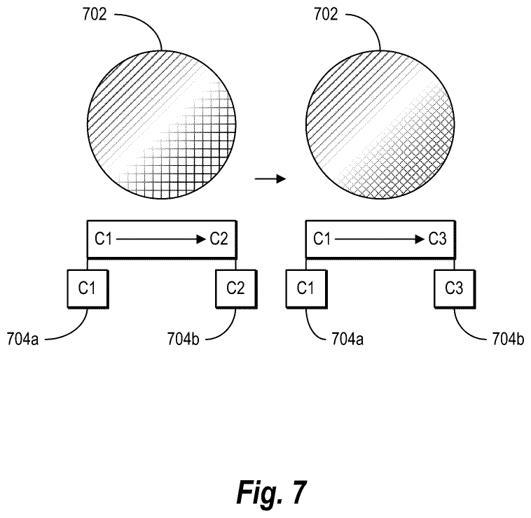

In one or more embodiments, the color reduction system 106 performs color reduction on a vector artwork that includes one or more gradient fills. FIG. 7 illustrates the color reduction system 106 replacing a color value that is part of a gradient fill in accordance with one or more embodiments. In one or more embodiments, a gradient fill includes a color fill that blends two or more color values. In particular, in some embodiments, a gradient fill includes a color fill that associates two or more color values with a vector path and blends the color values across the vector path. For instance, in some cases, a gradient fill includes two distinct color values at its ends and gradually blends the two color values toward the center of the gradient fill.

FIG. 7 illustrates a gradient fill 702 associated with a first color stop 704a and a second color stop 704b. In one or more embodiments, a color stop of a gradient fill includes a point along the gradient's path where a particular color value is defined. For instance, in some cases, a color stop indicates a point at which a color value is unblended. In some implementations, a color point behaves as a control point, indicating where one color value has fully transitioned into another color value. FIG. 7 illustrates the gradient fill 702 having two color stops, though a gradient fill includes more color stops in some instances. As shown in FIG. 7, the first color stop 704a is associated with a first color value and the second color stop 704b is associated with a second color value.

In one or more embodiments, the color reduction system 106 applies color reduction to a gradient fill by replacing one or more of the color values associated with its color stops. For instance, as shown in FIG. 7, the color reduction system 106 modifies the gradient fill 702 by replacing the second color value associated with the second color stop 704b with a third color value. For instance, in some cases, the color reduction system 106 determines that the second color value is not included in the reduced color palette, determines that the third color value is included in the reduced color palette, and determines (e.g., based on measures of similarity) that the third color value is more similar to the second color value than any other color value within the reduced color palette.

In one or more embodiments, the color reduction system 106 maintains the gradient fill 702 as a gradient fill (e.g., does not modify the gradient fill 702 to include a single color value) regardless of the similarities between the second color value and the color values in the reduced color palette. For instance, in some cases, the color reduction system 106 determines that the first color value associated with the first color stop 704a is in the reduced color palette and is the most similar to the second color value. Rather than associating the first color value with the second color stop 704b to replace the second color value—which would modify the gradient fill 702 to include a single color value—the color reduction system 106 replaces the second color value with the next most similar color value from the reduced color palette (e.g., the third color value). Thus, the color reduction system 106 maintains the visual character provided by the gradient fill 702 through the color reduction process.

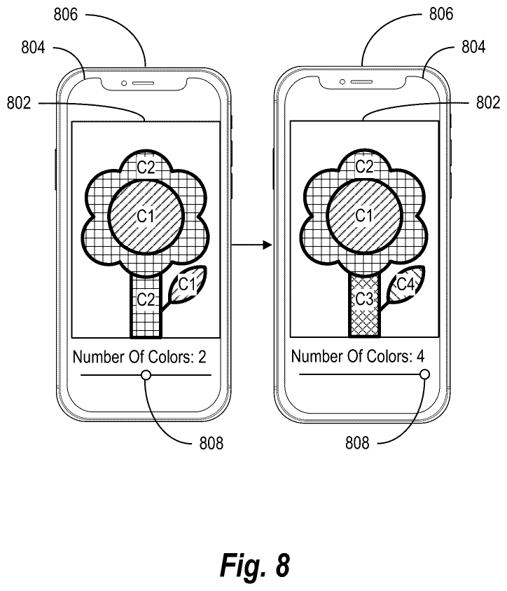

As discussed above, in one or more embodiments, the color reduction system 106 reduces the color palette of a vector artwork in response to receiving user input for reducing the color palette. In some embodiments, the color reduction system 106 further modifies the vector artwork based on additional user input changing the number of color values to represent within the vector artwork. For instance, in some cases, the color reduction system 106 receives additional user input to increase the number of color values represented in a vector artwork. FIG. 8 illustrates the color reduction system 106 increasing the number of color values for a vector artwork based on additional user input in accordance with one or more embodiments.

Indeed, FIG. 8 illustrates the color reduction system 106 providing a vector artwork 802 for display within a graphical user interface 804 of a client device 806. The vector artwork 802 includes a vector artwork that has been modified in accordance with user input to reduce its color palette. Indeed, as shown, the vector artwork 802 includes two color values. As further shown, the color reduction system 106 provides a slider element 808 within the graphical user interface 804 to facilitate additional user interaction.

As further shown in FIG. 8, the color reduction system 106 modifies the vector artwork 802 in response to receiving additional user input via the slider element 808. In particular, as indicated, the additional user input positions the slider element 808 to indicate an increase in the number of color values to be represented in the vector artwork 802. As further shown by the position of the slider element 808 (at the rightmost position), the additional user input indicates that the color palette of the vector artwork 802 is to be returned to its initial state. In other words, the additional user input indicates that the original color palette is to be returned to the vector artwork 802. Thus, the color reduction system 106 modifies the vector artwork 802 to return the original color palette. In particular, the color reduction system 106 modifies the vector artwork 802 to replace the subset of color values from the reduced color palette with the full set of color values from the original color palette. In some cases, the color reduction system 106 returns the vector artwork 802 to its initial state by saving the initial state of the vector artwork (e.g., saving the color values and their associated color paths) and applying the initial state upon detecting the additional user input for returning the vector artwork 802 to its initial state.

In one or more embodiments, the color reduction system 106 determines that the additional user input indicates a change to the reduced color palette but not a return to the original color palette. In other words, the color reduction system 106 determines that the additional user input indicates a change to the number of color values to be included in the reduced color palette. In some cases, in response to such additional user input, the color reduction system 106 refers back to the sorted list of color values determined for the vector artwork 802. In particular, the color reduction system 106 determines a new number of color values to be represented in the vector artwork 802 based on the additional user input and identifies that number of the top color values in the sorted list. Thus, the color reduction system 106 facilitates adjustments to the number of color values to be included in the reduced color palette, allowing a user to experiment to determine the reduced color palette that best represents a particular artistic vision.

Turning now to FIG. 9, additional detail will now be provided regarding various components and capabilities of the color reduction system 106. In particular, FIG. 9 illustrates the color reduction system 106 implemented by the computing device 900 (e.g., the server device(s) 102 and/or one of the client devices 110a-110n discussed above with reference to FIG. 1). Additionally, the color reduction system 106 is part of the design editing system 104. As shown, in one or more embodiments, the color reduction system 106 includes, but is not limited to, a color palette extractor 902, a color clustering engine 904, a color sorting engine 906, a reduced color palette manager 908, an vector art modification engine 910, and data storage 912 (which includes vector paths 914 and color values 916).

As just mentioned, and as illustrated in FIG. 9, the color reduction system 106 includes the color palette extractor 902. In one or more embodiments, the color palette extractor 902 extracts a color palette (e.g., an original color palette) from a vector artwork. For instance, in some cases, the color palette extractor 902 extracts a set of vector paths from a vector artwork and determines the set of color values associated with those vector paths. In some cases, the color palette extractor 902 further generates a color value map that maps the color values to their areas occupied within the vector artwork.

Additionally, as shown in FIG. 9, the color reduction system 106 includes the color clustering engine 904. In one or more embodiments, the color clustering engine 904 clusters one or more color values from the color palette of a vector artwork. To illustrate, in some embodiments, the color reduction system 106 determines measures of similarities among pairs of color values from the color palette. The color reduction system 106 further compares the measures of similarity to a threshold measure of similarity. Upon determining that a measure of similarity for two color values satisfies a threshold measure of similarity, the color reduction system 106 includes those color values in the same color value cluster. In some cases, the color reduction system 106 selects a representative color value for each color value cluster. For example, in some instances, the color reduction system 106 selects the color value from the color value cluster that is associated with the highest total area within the vector artwork as the representative color value. Additionally, in some instances, the color reduction system 106 generates a color value cluster map (e.g., by modifying a color value map) to map individual color values and/or color value clusters (e.g., their representative color values) to corresponding total areas.

As further shown in FIG. 9, the color reduction system 106 also includes the color sorting engine 906. In one or more embodiments, the color sorting engine 906 generates a sorted list of color values from the color values extracted from a vector artwork. For instance, in some cases, the color sorting engine 906 generates the sorted list of color values from a color value map or a color value cluster map generated from those color values. In some cases, the color sorting engine 906 sorts the included color values based on their dominance within the vector artwork. For instance, in certain cases, the color sorting engine 906 sorts the color values based on the total areas of the vector artwork associated with the color values.

As shown in FIG. 9, the color reduction system 106 further includes the reduced color palette manager 908. In one or more embodiments, the reduced color palette manager 908 determines a reduced color palette for a vector artwork. For instance, in some cases, the reduced color palette manager 908 receives user input and selects a number of color values to be represented within the vector artwork in accordance with the user input. In some instances, the reduced color palette manager 908 selects the color values from a sorted list of color values generated for the vector artwork. In some embodiments, the reduced color palette manager 908 manages the graphical user interface of the client device that displays the vector artwork, providing a slider element to be used in selecting a number of color values of the reduced color palette.

Additionally, as shown in FIG. 9, the color reduction system 106 includes the vector art modification engine 910. In one or more embodiments, the vector art modification engine 910 modifies a vector artwork. For instance, in some embodiments, the vector art modification engine 910 reduces the color palette represented in the vector artwork in accordance with received user input.

As shown in FIG. 9, the color reduction system 106 further includes data storage 912. In particular, data storage 912 includes vector paths 914 and color values 916.

Each of the components 902-916 of the color reduction system 106 optionally include software, hardware, or both. For example, in some cases, the components 902-916 include one or more instructions stored on a computer-readable storage medium and executable by processors of one or more computing devices, such as a client device or server device. When executed by the one or more processors, the computer-executable instructions of the color reduction system 106 cause the computing device(s) to perform the methods described herein. Alternatively, in some embodiments, the components 902-916 include hardware, such as a special-purpose processing device to perform a certain function or group of functions. Alternatively, in certain implementations, the components 902-916 of the color reduction system 106 include a combination of computer-executable instructions and hardware.

Furthermore, in one or more embodiments, the components 902-916 of the color reduction system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 902-916 of the color reduction system 106 are implemented as a stand-alone application, such as a desktop or mobile application. Furthermore, in some cases, the components 902-916 of the color reduction system 106 are implemented as one or more web-based applications hosted on a remote server. Alternatively, or additionally, the components 902-916 of the color reduction system 106 are implemented in a suite of mobile device applications or “apps.” For example, in one or more embodiments, the color reduction system 106 comprises or operates in connection with digital software applications such as ADOBE® ILLUSTRATOR® or ADOBE® EXPRESS®. The foregoing are either registered trademarks or trademarks of Adobe Inc. in the United States and/or other countries.

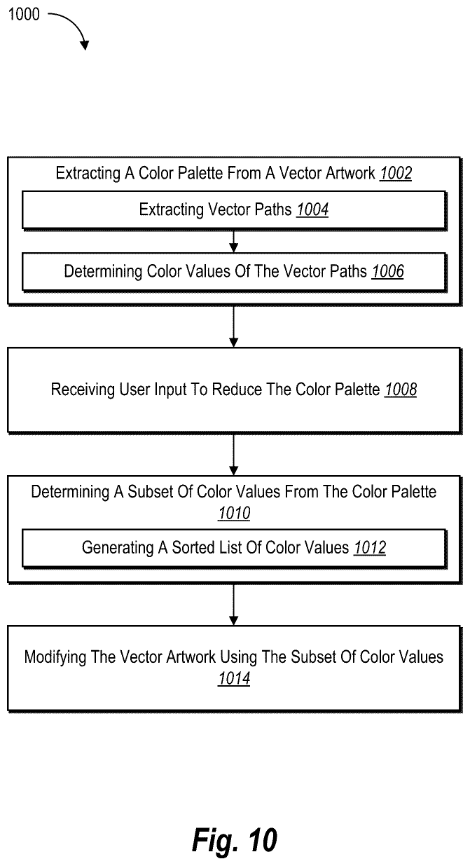

FIGS. 1-9, the corresponding text, and the examples provide a number of different methods, systems, devices, and non-transitory computer-readable media of the color reduction system 106. In addition to the foregoing, one or more embodiments are also described in terms of flowcharts comprising acts for accomplishing the particular result, as shown in FIG. 10. In one or more embodiments, FIG. 10 is performed with more or fewer acts. Further, in some embodiments, the acts are performed in different orders. Additionally, in some cases, the acts described herein are repeated or performed in parallel with one another or in parallel with different instances of the same or similar acts.

FIG. 10 illustrates a flowchart of a series of acts 1000 for reducing the color palette of a vector artwork while maintaining one or more original color values in accordance with one or more embodiments. FIG. 10 illustrates acts according to one embodiment, but alternative embodiments omit, add to, reorder, and/or modify any of the acts shown in FIG. 10. In some implementations, the acts of FIG. 10 are performed as part of a computer-implemented method. Alternatively, in some embodiments, a non-transitory computer-readable medium stores executable instructions thereon that, when executed by a processing device, cause the processing device to perform operations comprising the acts of FIG. 10. In some embodiments, a system performs the acts of FIG. 10. For example, in some cases, a system includes one or more memory devices. The system further includes one or more processors configured to cause the system to perform the acts of FIG. 10.

The series of acts 1000 includes an act 1002 for extracting a color palette from a vector artwork. For example, in one or more embodiments, the act 1002 involves extracting, from a vector artwork displayed within a graphical user interface of a client device, a color palette that includes a set of color values.

As shown in FIG. 10, the act 1002 includes a sub-act 1004 for extracting vector paths and a sub-act 1006 for determining color values of the vector paths. Indeed, in one or more embodiments, extracting the color palette of the vector artwork comprises extracting a set of vector paths from the vector artwork; and determining the set of color values of the color palette by determining a color value associated with each vector path from the set of vector paths. In some cases, the color reduction system 106 further determines that two or more vector paths from the set of vector paths are associated with a first color value from the set of color values; and generates, from the set of color values, a color value map that maps the first color value to a total area of the vector artwork corresponding to the two or more vector paths. Thus, in some cases, determining the subset of color values comprises determining the subset of color values using the color value map.

The series of acts 1000 also includes an act 1008 for receiving user input to reduce the color palette. For instance, in one or more embodiments, the act 1008 involves receiving, via the client device, user input for reducing the color palette of the vector artwork.

Additionally, the series of acts 1000 includes an act 1010 for determining a subset of color values from the color palette. To illustrate, in some embodiments, the act 1010 involves determining, in response to the user input, a subset of color values that includes one or more color values from the set of color values.

In one or more embodiments, the color reduction system 106 further determines a measure of similarity between a first color value and a second color value from the set of color values; and clusters, based on determining that the measure of similarity is within a threshold measure of similarity, the first color value and the second color value by selecting the first color value as a representative color value. As such, in some instances, determining the subset of color values comprises including the first color value within the subset of color values and omitting the second color value from the subset of color values based on clustering the first color value and the second color value.

As shown in FIG. 10, the act 1010 includes a sub-act 1012 for generating a sorted list of color values. For example, in some cases, the color reduction system 106 generates a sorted list of color values based on a total area of the vector artwork covered by each color value from the set of color values. Thus, in some embodiments, determining the subset of color values comprises determining the subset of color values using the sorted list of color values.

In some implementations, the color reduction system 106 further determines that the color palette of the vector artwork is in a cyan, magenta, yellow, and key (CMYK) color format; and converts the color palette from the CMYK color format to a red, green, and blue (RGB) color format. Thus, in one or more embodiments, determining the subset of color values comprises determining the subset of color values using the RGB color format.

Further, the series of acts 1000 includes an act 1014 for modifying the vector artwork using the subset of color values. For example, in some cases, the act 1014 involves modifying the vector artwork within the graphical user interface of the client device by reducing the set of color values within the vector artwork to the subset of color values.

In one or more embodiments, reducing the set of color values within the vector artwork to the subset of color values comprises replacing, within the vector artwork, a first color value omitted from the subset of color values with a second color value included in the subset of color values. In some embodiments, replacing, within the vector artwork, the first color value omitted from the subset of color values with the second color value included in the subset of color values comprises: determining a first Euclidean distance between the first color value and the second color value; determining a second Euclidean distance between the first color value and a third color value included in the subset of color values; and replacing the first color value with the second color value based on determining that the first Euclidean distance is less than the second Euclidean distance.

In some embodiments, the color reduction system 106 further receives, via the client device, additional user input for returning the color palette of the vector artwork to an initial state; and modifies the vector artwork within the graphical user interface of the client device by changing the subset of color values back to the set of color values within the vector artwork.

To provide an illustration, in one or more embodiments, the color reduction system 106 provides, for display within a graphical user interface of a client device, a vector artwork having a color palette and a slider element for modifying a number of color values from the color palette that are represented in the vector artwork; detects a user interaction with the slider element selecting a number of color values that is less than an initial number of color values from the color palette; determines a reduced color palette for the vector artwork by determining a subset of color values having the number of color values selected via the user interaction; and modifies the vector artwork within the graphical user interface of the client device by changing the color palette to the reduced color palette within the vector artwork.

In some embodiments, the color reduction system 106 further generates a color value map that maps color values from the color palette to total areas of the vector artwork occupied by the color values; modifies the color value map by clustering two or more color values from the color palette based on measures of similarity between the color values from the color palette; and determines the reduced color palette for the vector artwork by determining the reduced color palette using the modified color value map. Additionally, in some cases, the color reduction system 106 generates a sorted list of color values that sorts a set of color values in the modified color value map based on a total area of the vector artwork corresponding to each color value from the set of color values. As such, in some instances determining the subset of color values having the number of color values selected via the user interaction comprises selecting, from the sorted list of color values, a top number of color values that is equal to the number of color values selected via the user interaction.

In one or more embodiments, clustering the two or more color values from the color palette comprises: selecting a color value from the two or more color values to be a representative color value within the modified color value map based on a total area of the vector artwork occupied by the color value; and combining, within the modified color value map, the total area occupied by the color value and an additional total area occupied by each additional color value from the two or more color values. Additionally, in some embodiments, changing the color palette to the reduced color palette within the vector artwork comprises: determining to replace a first color value that was omitted from the reduced color palette, the first color value associated with a gradient fill of the vector artwork; and replacing the first color value with a second color value that was included in the reduced color palette by associating a color stop of the gradient fill with the second color value. Further, in some instances, changing the color palette to the reduced color palette within the vector artwork comprises replacing one or more fill colors within the vector artwork while maintaining one or more stroke colors.

To provide another illustration, in one or more embodiments, the color reduction system 106 extracts vector paths from a vector artwork having a color palette that includes a set of color values; generates, using the vector paths, a sorted list of color values based on a total area of the vector artwork that corresponds to each color value from the set of color values; receives, via a client device displaying the vector artwork, user input for reducing the color palette of the vector artwork; and modifies, in response to the user input, the vector artwork by reducing the set of color values within the vector artwork using the sorted list of color values.

In some embodiments, reducing the set of color values within the vector artwork comprises replacing one or more color values from the set of color values with one or more other color values from the set of color values. Additionally, in some cases, replacing the one or more color values with the one or more other color values from the set of color values comprises replacing a first color value with a second color value based on a Euclidean distance between the first color value and the second color value. In some implementations, generating, using the vector paths, the sorted list of color values based on the total area of the vector artwork that corresponds to each color value from the set of color values comprises generating, using the vector paths, the sorted list of color values based on total areas of the vector artwork that correspond to color value clusters determined from the set of color values, at least one color value cluster including two or more color values from the set of color values.

Some embodiments of the present disclosure comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, in some cases, one or more of the processes described herein are implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

In one or more embodiments, computer-readable media include various available media that is accessible by a general purpose or special purpose computer system. Computer-readable media that store computer-executable instructions are non-transitory computer-readable storage media (devices). Computer-readable media that carry computer-executable instructions are transmission media. Thus, by way of example, and not limitation, one or more embodiments of the disclosure comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which is usable to store desired program code means in the form of computer-executable instructions or data structures and which is accessible by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. In some cases, transmissions media includes a network and/or data links which are usable to carry desired program code means in the form of computer-executable instructions or data structures and which is accessible by a general purpose or special purpose computer. Combinations of the above should also be included within the scope of computer-readable media.

Further, upon reaching various computer system components, program code means in the form of computer-executable instructions or data structures is transferrable automatically from transmission media to non-transitory computer-readable storage media (devices) (or vice versa). For example, in some cases, computer-executable instructions or data structures received over a network or data link are buffered in RAM within a network interface module (e.g., a “NIC”), and then eventually transferred to computer system RAM and/or to less volatile computer storage media (devices) at a computer system. Thus, it should be understood that, in some cases, non-transitory computer-readable storage media (devices) are included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. In some instances, the computer executable instructions are, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that one or more embodiments are practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. Some implementations are practiced in distributed system environments where local and remote computer systems, which are linked (either by hardwired data links, wireless data links, or by a combination of hardwired and wireless data links) through a network, both perform tasks. In some implementations, in a distributed system environment, program modules are located in both local and remote memory storage devices.

Some embodiments of the present disclosure are implemented in cloud computing environments. In this description, “cloud computing” is defined as a model for enabling on-demand network access to a shared pool of configurable computing resources. For example, in some cases, cloud computing is employed in the marketplace to offer ubiquitous and convenient on-demand access to the shared pool of configurable computing resources. In some instances, the shared pool of configurable computing resources is rapidly provisioned via virtualization and released with low management effort or service provider interaction, and then scaled accordingly.

In one or more embodiments, a cloud-computing model is composed of various characteristics such as, for example, on-demand self-service, broad network access, resource pooling, rapid elasticity, measured service, and so forth. In some embodiments, a cloud-computing model exposes various service models, such as, for example, Software as a Service (“SaaS”), Platform as a Service (“PaaS”), and Infrastructure as a Service (“IaaS”). In some instances, a cloud-computing model is deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that is configured to perform one or more of the processes described above in some embodiments. One will appreciate that one or more computing devices, such as the computing device 1100, represent the computing devices described above (e.g., the server device(s) 102 and/or the client devices 110a-110n) in some implementations. In one or more embodiments, the computing device 1100 is a mobile device (e.g., a mobile telephone, a smartphone, a PDA, a tablet, a laptop, a camera, a tracker, a watch, a wearable device). In some embodiments, the computing device 1100 is a non-mobile device (e.g., a desktop computer or another type of client device). Further, in certain embodiments, the computing device 1100 is a server device that includes cloud-based processing and storage capabilities.

As shown in FIG. 11, the computing device 1100 includes one or more processor(s) 1102, memory 1104, a storage device 1106, input/output interfaces 1108 (or “I/O interfaces 1108”), and a communication interface 1110, which are communicatively coupled by way of a communication infrastructure (e.g., bus 1112). While the computing device 1100 is shown in FIG. 11, the components illustrated in FIG. 11 are not intended to be limiting. Additional or alternative components are used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 retrieve (or fetch) the instructions from an internal register, an internal cache, memory 1104, or a storage device 1106 and decode and execute them in some implementations.

The computing device 1100 includes memory 1104, which is coupled to the processor(s) 1102. In certain cases, the memory 1104 is used for storing data, metadata, and programs for execution by the processor(s). In some instances, the memory 1104 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some embodiments, the memory 1104 includes internal or distributed memory.

The computing device 1100 includes a storage device 1106 including storage for storing data or instructions. As an example, and not by way of limitation, in some cases, the storage device 1106 includes a non-transitory storage medium described above. In some embodiments, the storage device 1106 includes a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. In one or more embodiments, these I/O interfaces 1108 include a mouse, keypad or a keyboard, a touch screen, camera, optical scanner, network interface, modem, other known I/O devices or a combination of such I/O interfaces 1108. In some cases, the touch screen is activated with a stylus or a finger.

In one or more embodiments, the I/O interfaces 1108 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. In some cases, the graphical data is representative of one or more graphical user interfaces and/or any other graphical content that serves a particular implementation.

The computing device 1100 further includes a communication interface 1110. In some cases, the communication interface 1110 includes hardware, software, or both. The communication interface 1110 provides one or more interfaces for communication (such as, for example, packet-based communication) between the computing device and one or more other computing devices or one or more networks. As an example, and not by way of limitation, in some cases, communication interface 1110 includes a network interface controller (NIC) or network adapter for communicating with an Ethernet or other wire-based network or a wireless NIC (WNIC) or wireless adapter for communicating with a wireless network, such as a WI-FI. The computing device 1100 further includes a bus 1112. In some cases, the bus 1112 includes hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

Various implementations of the present invention are embodied in other specific forms without departing from its spirit or essential characteristics. The described embodiments are to be considered in all respects only as illustrative and not restrictive. For example, in some embodiments, the methods described herein are performed with less or more steps/acts or the steps/acts are performed in differing orders. Additionally, in some cases, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
extracting, from a vector artwork displayed within a graphical user interface of a client device, a color palette that includes a set of color values;
receiving, via the client device, user input for reducing the color palette of the vector artwork;
determining, in response to the user input, a subset of color values that includes one or more color values from the set of color values; and
modifying the vector artwork within the graphical user interface of the client device by reducing the set of color values within the vector artwork to the subset of color values.

2. The computer-implemented method of claim 1, wherein extracting the color palette of the vector artwork comprises:
extracting a set of vector paths from the vector artwork; and
determining the set of color values of the color palette by determining a color value associated with each vector path from the set of vector paths.

3. The computer-implemented method of claim 2, wherein further comprising:
determining that two or more vector paths from the set of vector paths are associated with a first color value from the set of color values; and
generating, from the set of color values, a color value map that maps the first color value to a total area of the vector artwork corresponding to the two or more vector paths,
wherein determining the subset of color values comprises determining the subset of color values using the color value map.

4. The computer-implemented method of claim 1, further comprising:
determining a measure of similarity between a first color value and a second color value from the set of color values; and
clustering, based on determining that the measure of similarity is within a threshold measure of similarity, the first color value and the second color value by selecting the first color value as a representative color value.

5. The computer-implemented method of claim 4, wherein determining the subset of color values comprises including the first color value within the subset of color values and omitting the second color value from the subset of color values based on clustering the first color value and the second color value.

6. The computer-implemented method of claim 1,
further comprising generating a sorted list of color values based on a total area of the vector artwork covered by each color value from the set of color values,
wherein determining the subset of color values comprises determining the subset of color values using the sorted list of color values.

7. The computer-implemented method of claim 1, wherein reducing the set of color values within the vector artwork to the subset of color values comprises replacing, within the vector artwork, a first color value omitted from the subset of color values with a second color value included in the subset of color values.

8. The computer-implemented method of claim 7, wherein replacing, within the vector artwork, the first color value omitted from the subset of color values with the second color value included in the subset of color values comprises:
determining a first Euclidean distance between the first color value and the second color value;
determining a second Euclidean distance between the first color value and a third color value included in the subset of color values; and
replacing the first color value with the second color value based on determining that the first Euclidean distance is less than the second Euclidean distance.

9. The computer-implemented method of claim 1, further comprising:
receiving, via the client device, additional user input for returning the color palette of the vector artwork to an initial state; and
modifying the vector artwork within the graphical user interface of the client device by changing the subset of color values back to the set of color values within the vector artwork.

10. The computer-implemented method of claim 1, further comprising:
determining that the color palette of the vector artwork is in a cyan, magenta, yellow, and key (CMYK) color format; and
converting the color palette from the CMYK color format to a red, green, and blue (RGB) color format,
wherein determining the subset of color values comprises determining the subset of color values using the RGB color format.

11. A system comprising:
one or more memory devices; and
one or more processors configured to cause the system to:
provide, for display within a graphical user interface of a client device, a vector artwork having a color palette and a slider element for modifying a number of color values from the color palette that are represented in the vector artwork;
detect a user interaction with the slider element selecting a number of color values that is less than an initial number of color values from the color palette;
determine a reduced color palette for the vector artwork by determining a subset of color values having the number of color values selected via the user interaction; and
modify the vector artwork within the graphical user interface of the client device by changing the color palette to the reduced color palette within the vector artwork.

12. The system of claim 11, wherein the one or more processors are further configured to cause the system to:
generate a color value map that maps color values from the color palette to total areas of the vector artwork occupied by the color values;
modify the color value map by clustering two or more color values from the color palette based on measures of similarity between the color values from the color palette; and
determine the reduced color palette for the vector artwork by determining the reduced color palette using the modified color value map.

13. The system of claim 12, wherein:
the one or more processors are further configured to cause the system to generate a sorted list of color values that sorts a set of color values in the modified color value map based on a total area of the vector artwork corresponding to each color value from the set of color values; and
determining the subset of color values having the number of color values selected via the user interaction comprises selecting, from the sorted list of color values, a top number of color values that is equal to the number of color values selected via the user interaction.

14. The system of claim 12, wherein clustering the two or more color values from the color palette comprises:
selecting a color value from the two or more color values to be a representative color value within the modified color value map based on a total area of the vector artwork occupied by the color value; and
combining, within the modified color value map, the total area occupied by the color value and an additional total area occupied by each additional color value from the two or more color values.

15. The system of claim 11, wherein changing the color palette to the reduced color palette within the vector artwork comprises:
determining to replace a first color value that was omitted from the reduced color palette, the first color value associated with a gradient fill of the vector artwork; and
replacing the first color value with a second color value that was included in the reduced color palette by associating a color stop of the gradient fill with the second color value.

16. The system of claim 11, wherein changing the color palette to the reduced color palette within the vector artwork comprises replacing one or more fill colors within the vector artwork while maintaining one or more stroke colors.

17. A non-transitory computer-readable medium storing executable instructions which, when executed by a processing device, cause the processing device to perform operations comprising:
extracting vector paths from a vector artwork having a color palette that includes a set of color values;
generating, using the vector paths, a sorted list of color values based on a total area of the vector artwork that corresponds to each color value from the set of color values;
receiving, via a client device displaying the vector artwork, user input for reducing the color palette of the vector artwork; and
modifying, in response to the user input, the vector artwork by reducing the set of color values within the vector artwork using the sorted list of color values.

18. The non-transitory computer-readable medium of claim 17, wherein reducing the set of color values within the vector artwork comprises replacing one or more color values from the set of color values with one or more other color values from the set of color values.

19. The non-transitory computer-readable medium of claim 18, wherein replacing the one or more color values with the one or more other color values from the set of color values comprises replacing a first color value with a second color value based on a Euclidean distance between the first color value and the second color value.

20. The non-transitory computer-readable medium of claim 17, wherein generating, using the vector paths, the sorted list of color values based on the total area of the vector artwork that corresponds to each color value from the set of color values comprises generating, using the vector paths, the sorted list of color values based on total areas of the vector artwork that correspond to color value clusters determined from the set of color values, at least one color value cluster including two or more color values from the set of color values.
